(19) United States
(12) Patent Application Publication
(10) Pub. No.: US 2008/0007573 A1
(43) Pub. Date: Jan. 10, 2008

(54) Display device and display system employing same

(75) Inventors: Kesatoshi Takeuchi, Shioziri-shi (JP); Takahiro Sagawa, Chino-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, TOKYO (JP)

(21) Appl. No.: 11/798,591

(22) Filed: May 15, 2007

(30) Foreign Application Priority Data
Jul. 4, 2006 (JP) 2006-184305

(51) Int. Cl. G09G 5/10

(52) U.S. Cl. 345/690

(57) ABSTRACT

To provide a technique to prevent an occurrence of flicker due to overlap periods during display of moving pictures. A display device includes: a plurality of light outputting elements; and a plurality of element controllers corresponding to the plurality of light outputting elements. In response to a predetermined signal provided to the plurality of element controllers at same timing, each of the plurality of element controllers supplies the light outputting element with pixel data included in image data that represents an image to be displayed by the display device, and controls an operating status of the light outputting element.

### CROSS REFERENCE

The present application claims the priority based on Japanese Patent Application No. 2006-184305 filed on Jul. 4, 2006, the disclosure of which is hereby incorporated by reference in its entirety.

### BACKGROUND

1. Technical Field

The present invention relates to display device technology.

2. Related Art

Typically, a display device has a plurality of light outputting elements arranged in a matrix configuration, and an image is displayed by setting the operating status of the plurality of light outputting elements. During this time, the image is displayed by sequentially scanning a plurality of scan lines.

Japanese Patent Application Laid-Open Gazette No. 2003-66918 discloses technology for displaying a black image during a period between a first frame image and a second frame image by sequentially scanning a plurality of scan lines, thereby reducing blur in moving picture. Japanese Patent Application Laid-Open Gazette No. 2002-287700 discloses technology for reducing moving picture blur by driving a backlight for a liquid crystal panel intermittently.

When moving pictures are displayed by a display device, there is typically an overlap period in which part of the first frame image and part of the second frame image following the first frame image are displayed at a time. If such overlap periods are present, there is a problem that flicker occurs.

### SUMMARY

This invention is intended to address the problems of the related art discussed above, and has an object to prevent the occurrence of flicker due to overlap periods during display of moving pictures.

In a first aspect of the present invention, a display device includes: a plurality of light outputting elements; and a plurality of element controllers corresponding to the plurality of light outputting elements, wherein in response to a predetermined signal provided to the plurality of element controllers at same timing, each of the plurality of element controllers supplies the light outputting element with pixel data included in image data that represents an image to be displayed by the display device, and controls an operating status of the light outputting element.

In this device, since the operating status of the plurality of light outputting elements is changed simultaneously in response to the predetermined signal provided to the plurality of element controller at the same timing, an image to be displayed by the display device can be changed all at one time. In other words, it is possible to eliminate an overlap period during which part of a first image and part of a second image are displayed at a time. It is thereby possible to prevent the occurrence of flicker due to overlap periods during display of moving pictures.

In a second aspect of the present invention, a display system includes: the above display device; a light source device that emits light towards the plurality of light outputting elements; and a controller that controls the light source device such that light intermittently enters the plurality of light outputting elements.

Where light intermittently enters the plurality of light outputting elements in this way, moving picture blur can be reduced.

In a third aspect of the present invention, a display device includes: a plurality of light outputting elements; and an operating status controller that simultaneously controls operating status of the plurality of light outputting elements at predetermined timing, such that an image displayed by the display device is changed all at one time from a first image to a second image different from the first image.

In this device, since the operating status of the plurality of light outputting elements is changed simultaneously at predetermined timing, an image displayed by the display device can be changed all at one time from a first image to a second image. In other words, it is possible to eliminate the overlap period. It is thereby possible to prevent the occurrence of flicker due to overlap periods during display of moving pictures.

It should be noted that the present invention may be actualized by a diversity of applications such as a display device, a control method for the device, a display system including the display device, a control method for the system, computer programs that attain these methods or functions of these apparatuses, recording media in which such computer programs are recorded, and data signals that include such computer programs and are embodied in carrier waves.

These and other objects, features, aspects, and advantages of the present invention will become more apparent from the following detailed description of the preferred embodiments with the accompanying drawings.

### BRIEF DESCRIPTION OF THE DRAWINGS

FIG. 1 shows a simplified configuration of a projector PJ in the first embodiment;

FIG. 2 shows an internal configuration of the liquid crystal light valve 200R;

FIG. 3 shows an internal configuration of the (m, n)-th cell 302;

FIGS. 4(a)-4(e) are timing charts relating to operation of the liquid crystal light valve 200R in the first embodiment;

FIG. 5 shows a simplified configuration of a projector PJB in the second embodiment; and

FIGS. 6(a)-6(g) are timing charts relating to operation of the liquid crystal light valve 220R in the second embodiment.

### DESCRIPTION OF THE PREFERRED EMBODIMENT

Embodiments of the present invention are discussed below based on examples in the following order.

### A. First Embodiment

A-1. Projector Configuration

A-2. Liquid Crystal Light Valve Configuration

A-3. Liquid Crystal Light Valve Operation

### B. Second Embodiment

### A. First Embodiment

### A-1. Projector Configuration

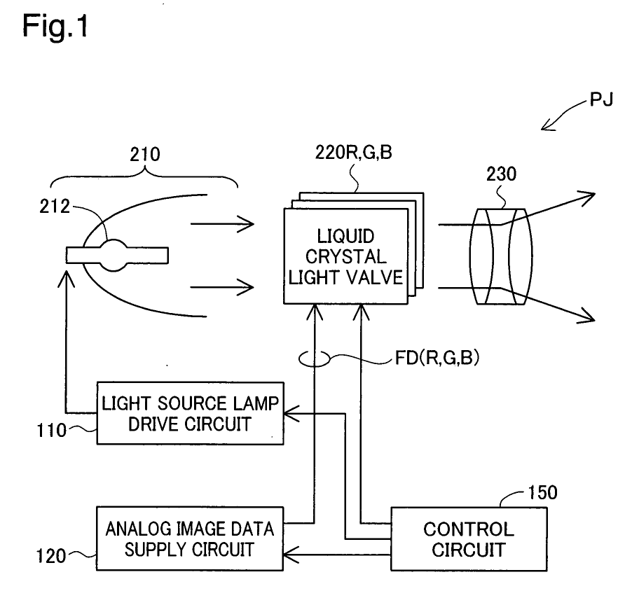

FIG. 1 shows a simplified configuration of a projector PJ in the first embodiment. The projector PJ includes an illumination optical system 210 for emitting three colored lights (i.e. red light, green light, and blue light), three liquid crystal light valves 220R, G, B, and a projection optical system 230. In FIG. 1, the illustration of the optical systems has been simplified considerably. In addition, the projector PJ includes a light source lamp drive circuit 110, an analog image data supply circuit 120, and a control circuit 150.

The light source lamp drive circuit 110 supplies power to a light source lamp 212 included in the illumination optical system 210, and drives the light source lamp 212.

The analog image data supply circuit 120 supplies analog image data FD to the three liquid crystal light valves 220R, G, B. The analog image data FD includes three color data R, G, B, with the three color data R, G, B being supplied respectively to the three liquid crystal light valves 220R, G, B.

Within the analog image data supply circuit 120, processes such as the following are executed, for example. First analog image data supplied externally is converted to first digital image data and written to a frame memory, and second digital image data is read from the frame memory and converted to second analog image data. The second analog image data is generated utilizing a synchronization signal that is appropriate for the liquid crystal light valves 220R, G, B and is supplied from the control circuit 150. The second analog image data has resolution (pixel count) appropriate for the liquid crystal light valves 220R, G, B. In order to reduce deterioration of liquid crystal elements (more specifically, liquid crystal material), the polarity of the second analog image data is reversed for each frame, for example. In this way, analog image data FD appropriate for the liquid crystal light valves 220R, G, B is output from the analog image data supply circuit 120.

Using the three color data R, G, B included in the analog image data FD supplied from the analog image data supply circuit 120, the three liquid crystal light valves 220R, G, B modulate the three colored lights emitted from the illumination optical system 210. Light representing image of each color (i.e. image light) is formed thereby on the output surface of each liquid crystal light valve 220R, G, B.

The projection optical system 230 projects the image lights for three colors formed on the liquid crystal light valves 220R, G, B onto a screen, forming a full-color image on the screen.

The control circuit 150 controls the light source lamp drive circuit 110 to supply power to the light source lamp 212. In addition, the control circuit 150 controls the analog image data supply circuit 120 to generate analog image data FD appropriate for the liquid crystal light valves 220R, G, B. Further, the control circuit 150 controls the liquid crystal light valves 220R, G, B to generate the image lights according to the analog image data FD.

Note that, each liquid crystal light valve 220R, G, B in the present embodiment corresponds to a display device in the present invention.

A-2. Liquid Crystal Light Valve Configuration

In the present embodiment, the liquid crystal light valve 220R, G, B includes a liquid crystal panel of the type known as LCOS (Liquid Crystal on Silicon). As is widely known, LCOS have a structure in which a liquid crystal layer is sandwiched between a silicon substrate and a transparent substrate.

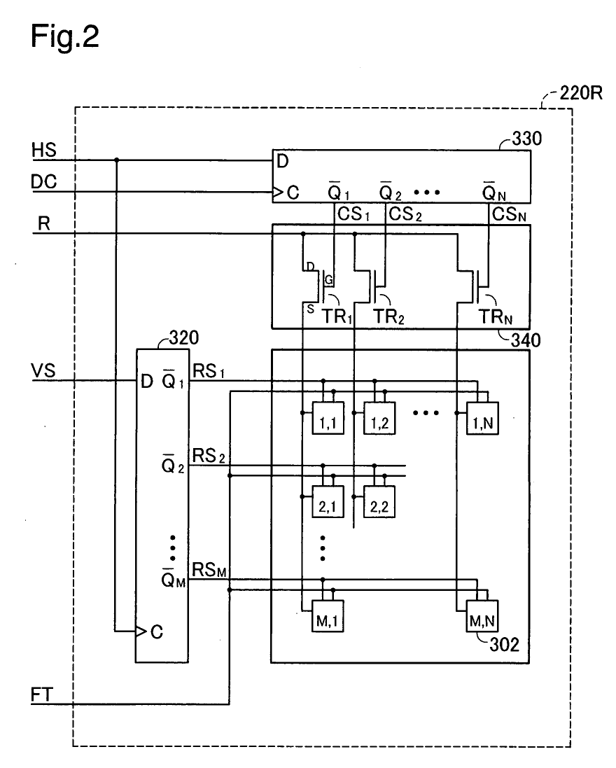

FIG. 2 shows an internal configuration of the liquid crystal light valve 200R. The other liquid crystal light valves 220G, B are of similar configuration.

The liquid crystal light valve 220R includes a cell array and a drive circuitry. The cell array contains M×N cells 302 arrayed in an M×N matrix configuration (M rows, N columns). The drive circuitry includes a row selection circuit 320, a column selection circuit 330, and a pixel data supply circuit 340. Note that, the row selection circuit 320 is also referred to as a scan line driver, and a circuitry including the column selection circuit 330 and the pixel data supply circuit 340 is also referred to as a data driver. The drive circuitry is formed on the silicon substrate, together with the electrical circuitry included in the cell array.

The row selection circuit 320 includes a shift register, and is furnished with a data terminal D, a clock terminal C, and a number M of output terminals #Q₁ to #Q_{M}. The symbol “#” denotes negative logic, and in FIG. 2, negative logic is represented by the symbol “- (bar)”. The data terminal D is presented with a vertical synchronization signal VS supplied by the control circuit 150, while the clock terminal C is presented with a horizontal synchronization signal HS supplied by the control circuit 150. The two synchronization signals VS, HS have frequencies appropriate for the liquid crystal light valves 220R, G, B, and contain an L level pulse. A number M of row selection signals RS₁ to RS_{M} containing an H level pulse are output from the M output terminals #Q₁ to #Q_{M}. Each row selection signal RS₁ to RS_{M} has a cycle of 1V (i.e. the cycle of the vertical synchronization signal VS), and the phase of each row selection signal RS₁ to RS_{M} is sequentially shifted by 1 H period (i.e. the cycle of the horizontal synchronization signal HS).

The m-th (1≦m≦M) output terminal #Qₘ of the row selection circuit 320 is connected to a number N of the cells 302 located in the m-th row of the cell array, and the N cells 302 are presented with the m-th row select signal RSₘ.

The column selection circuit 330 includes a shift register, and is furnished with a data terminal D, a clock terminal C, and a number N of output terminals #Q₁ to #Q_{N}. The data terminal D is presented with the horizontal synchronization signal VS supplied by the control circuit 150, while the clock terminal C is presented with a dot clock signal DC supplied by the control circuit 150. The dot clock signal DC has a cycle equal to the output period of pixel data equivalent to one pixel, included in the color data R, G, B that constitutes the analog image data FD. A number N of column selection signals CS₁ to CS_{N} containing an H level pulse are output from the N output terminals #Q₁ to #Q_{N}. Each column selection signal CSI to CS_{N} has a cycle of 1 H, and the phase of each column selection signal CS₁ to CS_{N} is sequentially shifted by the cycle of the dot clock DC.

The pixel data supply circuit 340 includes a number N of n-channel field effect transistors TR₁ to TR_{N}. The pixel data supply circuit 340 receives the color data R supplied from the analog image data supply circuit 120, and supplies the pixel data contained in the color data R to the corresponding cells 302 in the cell array.

A gate terminal G of the n-th (1≦n≦N) transistor TRₙ of the pixel data supply circuit 340 is connected to the n-th output terminal #Qₙ of the row selection circuit 320 and is presented with the n-th row selection signal CSₙ A drain terminal D of the n-th transistor TRₙ is presented with the color data R. It should be noted that the color data R is presented in common to the drain terminals D of the N transistors TR₁ to TR_{N}. A source terminal S of the n-th transistor TRₙ is connected to a number M of the cells 302 located in the n-th column of the cell array, and the M cells 302 are presented with pixel data equivalent to one pixel included in the color data R in accordance with the n-th column selection signal CSₙ. However, among the M cells 302 located in the n-th column, only the one cell located in the m-th row that is selected by the m-th row selection signal RSₘ receives the pixel data.

Hereinbelow, the cell 302 located in the m-th row and the n-th column shall be referred to as the “(m, n)-th” cell 302.

As mentioned above, the (m, n)-th cell 302 is presented with the m-th row selection signal RSₘ supplied from the row selection circuit 320, and with pixel data supplied from the n-th transistor TRₙ of the pixel data supply circuit 340. The M×N cells 302 are presented in common with a transfer signal FT supplied from the control circuit 150.

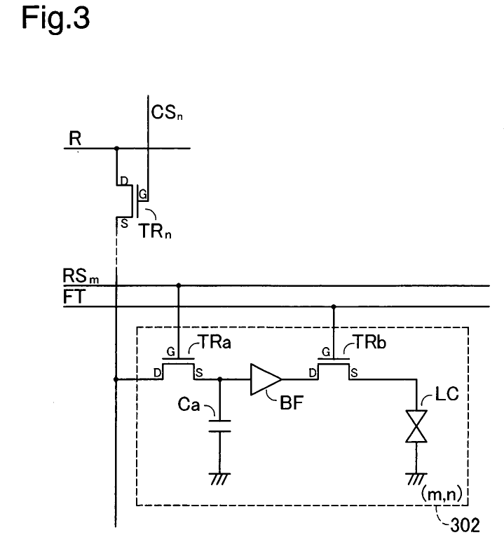

FIG. 3 shows an internal configuration of the (m, n)-th cell 302. In FIG. 3, the n-th transistor TRₙ included in the pixel data supply circuit 340 (FIG. 2) is shown as well.

As shown in the drawing, the (m, n)-th cell 302 includes a liquid crystal element LC, a capacitor Ca, two n-channel field effect transistors TRa, TRb, and a buffer circuit BF. The liquid crystal element LC has the function of holding a charge, in a manner similar to a capacitor.

The gate terminal G of the first transistor TRa is connected to the m-th output terminal #Qₘ of the row selection circuit 320, and is presented with the m-th row selection signal RSₘ. The drain terminal D of the first transistor TRa is connected to the source terminal S of the n-th transistor TRₙ included in the pixel data supply circuit 340, and is presented with pixel data. The source terminal S of the first transistor TRa is connected to the input terminal of the buffer circuit BF and to one of the terminals of the capacitor Ca. The other terminal of the capacitor Ca is set to predetermined potential (e.g. GND).

The gate terminal G of the second transistor TRb is presented with the transfer signal FT supplied from the control circuit 150. The drain terminal D of the second transistor TRb is connected to the output terminal of the buffer circuit BF. The source terminal S of the second transistor TRb is connected to one of the terminals of the liquid crystal element LC. The other terminal of the liquid crystal element LC is set to predetermined potential (e.g. GND).

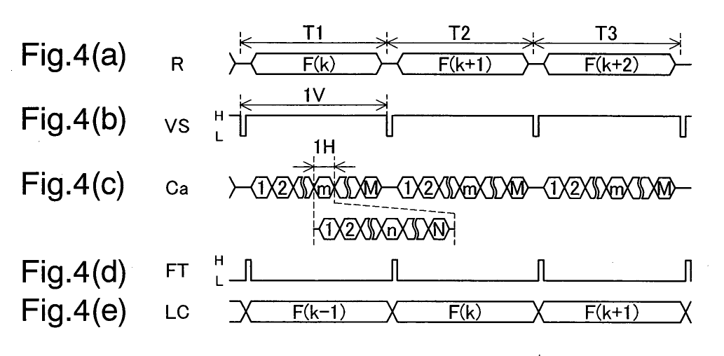

A-3. Liquid Crystal Light Valve Operation FIGS. 4(a)-4(e) are timing charts relating to operation of the liquid crystal light valve 200R in the first embodiment. FIG. 4 (a) shows the color data R supplied by the analog image data supply circuit 120. FIG. 4 (b) shows the vertical synchronization signal VS supplied by the control circuit 150. FIG. 4 (c) shows the timing of storage of data in the capacitor Ca. FIG. 4 (d) shows the transfer signal FT supplied by the control circuit 150. In the present embodiment, the transfer signal FT is a signal created by inverting and delaying the vertical synchronization signal VS. Specifically, the transfer signal FT has the same frequency as the vertical synchronization signal VS, and the H level pulses contained in the transfer signal FT are generated at a slight delay relative to the L level pulses contained in the vertical synchronization signal VS. FIG. 4 (e) shows data held by the liquid crystal elements LC, specifically, data determining the operating status of the liquid crystal elements LC. In the present embodiment, the light source lamp 212 is maintained in the lit state.

In the drawing, periods T1 to T3 are 1V periods. During the 1V period, the M row selection signals RS₁ to RS_{M} are sequentially set to H level. Then, during the 1 H period in which each of the row selection signals RS₁ to RS_{M} is set to H level, the N column selection signals CS₁ to CS_{N} are sequentially set to H level.

During the first period T1, the M×N pixel data making up the k-th frame image data F(k) (FIG. 4(a)) is sequentially stored at mutually different timing in the M×N capacitors Ca (FIG. 4(c)) within the M×N cells 302. Here, the specifics of operation will be described focusing on the (m, n)-th cell 302. When the m-th row selection signal RSₘ is set to H level, the N first transistors TRa within the N cells 302 of the m-th row becomes the ON state, producing a state in which pixel data can be stored to the N capacitors Ca. In this state, when the n-th column selection signal CSₙ is set to H level, the n-th transistor TRₙ included in the pixel data supply circuit 340 becomes the ON state. At this time, the (m, n)-th pixel data contained in the color data R is stored in the capacitor Ca of the (m, n)-th cell 302, via the transistor TRₙ in question and the first transistor TRa within the cell 302 in question. More specifically, the capacitor Ca within the (m, n)-th cell 302 accumulates charge, and as a result the voltage of the capacitor Ca in question is set to a value depending on the voltage of the (m, n)-th pixel data. In this way, during the first period T1, the M×N cells 302 are selected at mutually different timing by means of the row selection signals RS₁ to RS_{M} and the column selection signals CS₁ to CS_{N}. Then, the M×N pixel data making up the k-th frame image data F(k) is sequentially stored at mutually different timing in the M×N capacitors Ca. The voltage of the capacitors Ca is maintained throughout the 1V period. Specifically, the voltage of the capacitor Ca of the (m, n)-th cell 302 is maintained until the m-th row selection signal RSₘ and the n-th column selection signal CSₙ are both set to H level in the second period T2.

In the first period T1, the M×N liquid crystal elements LC (FIG. 4(e)) hold the M×N pixel data making up the (k−1)-th frame image data F(k−1) of, and are set to operating status determined by the M×N pixel data. The light emitted from the light source lamp 212 is modulated according to the operating status of the M×N liquid crystal elements LC, whereby the (k−1)-th frame image is displayed.

After the M×N pixel data making up the k-th frame image data F(k) has been sequentially stored in the M×N capacitors Ca, the transfer signal FT (FIG. 4(d)) is set to H level. When the transfer signal FT is set to H level, the M×N second transistors TRb simultaneously become the ON state. At this time, the M×N pixel data making up the k-th frame image data F(k) which has been stored in the M×N capacitors Ca is now transferred simultaneously to and held in the M×N liquid crystal elements LC (FIG. 4(e)). That is, the M×N pixel data making up the image data F(k−1) which has been held in the M×N liquid crystal elements LC is now changed all at once to the M×N pixel data making up the image data F(k). The M×N liquid crystal elements LC (FIG. 4(e)) then simultaneously change operating status on the basis of the updated M×N pixel data. At this time, the light emitted from the light source lamp 212 is modulated simultaneously according to the operating status of the M×N liquid crystal elements LC after the change. The k-th frame image is thereby displayed in place of the (k−1)-th frame image.

When the transfer signal FT (FIG. 4(d)) returns to L level, the M×N second transistors TRb become the OFF state, and the pixel data supplied to the M×N liquid crystal elements LC is held throughout the 1V period. Thus, operating status of M×N liquid crystal elements LC is maintained throughout the 1V period, and the k-th frame image is displayed throughout the 1V period.

In the present embodiment, the buffer circuit BF has the function of amplifying the value of the pixel data stored in the capacitor Ca during transfer, such that the value (voltage value) of the pixel data stored in the capacitor Ca and the value (voltage value) of the pixel data received and held in the liquid crystal element LC subsequent to the transfer are equal one another. By so doing, change in values (voltage values) of pixel data during transfer of the pixel data from the capacitor Ca to the liquid crystal element LC is avoided.

During the other periods T2, T3, a process similar to that described above is executed. For example, during the second period T2, the M×N pixel data making up the (k+1)-th frame image data F(k+1) is sequentially stored in the M×N capacitors Ca (FIG. 4(c)). Then, in accordance with the transfer signal FT, the M×N pixel data stored in the M×N capacitors Ca is transferred all at once to the M×N liquid crystal elements LC (FIG. 4(e)). The M×N liquid crystal elements LC then change operating status all at once, on the basis of the supplied M×N pixel data. The (k+1)-th frame image is thereby displayed in place of the k-th frame image.

As discussed above, in the present embodiment, the plurality of pixel data stored in the plurality of capacitors Ca is simultaneously supplied to the plurality of liquid crystal elements LC in accordance with the transfer signal FT, and the plurality of liquid crystal elements LC change operating status simultaneously such that the image to be displayed by the display device can be changed all at once. In other words, it is possible to eliminate the overlap period during which part of a first image (e.g. the k-th frame image) and part of a second image (e.g. the (k+1)-th frame image) are displayed at a time. It is possible thereby to prevent the occurrence of flicker due to overlap periods during display of moving pictures.

From the preceding discussion it will be apparent that the plurality of liquid crystal elements LC within the plurality of cells 302 in the present embodiment correspond to a plurality of light outputting elements in the present invention, and that the plurality of element groups Ca, TRa, TRb, BF except for the plurality of liquid crystal elements LC within the plurality of cells 302 correspond to a plurality of element controllers in the present invention and a operating status controller in the present invention. In particular, the capacitor Ca in the present embodiment correspond to a memory section in the present invention, the second transistor TRb and the buffer circuit BF correspond to a supply section, and the first transistor TRa corresponds to an acquiring section. In addition, the buffer circuit BF also corresponds to an amplifying section in the present invention. The row selection circuit 320 and the column selection circuit 330 included in the drive circuitry correspond to a selector in the present invention.

While the configuration of the present embodiment is suitable for display of moving pictures, it may be applicable for display of still pictures.

### B. Second Embodiment

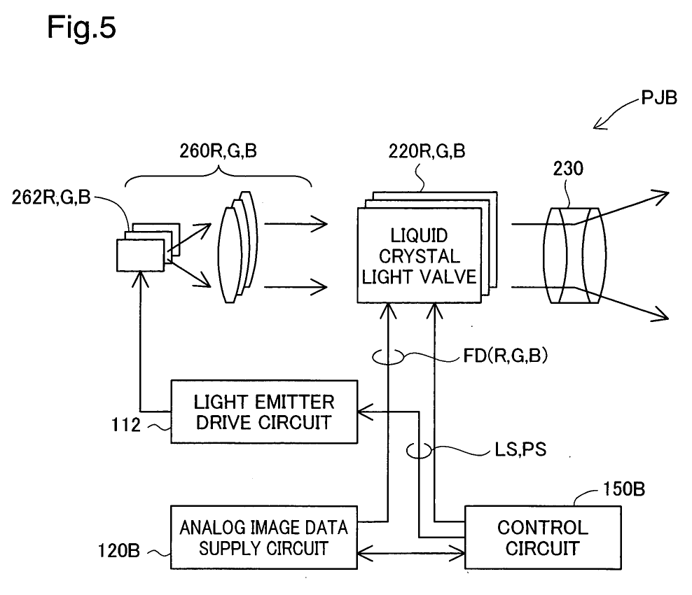

FIG. 5 shows a simplified configuration of a projector PJB in the second embodiment. FIG. 5 is similar to FIG. 1, except for three illumination optical systems 260R, G, B, a light emitter drive circuit 112, an analog image data supply circuit 120B, and a control circuit 150B.

The three illumination optical systems 260R, G, B include light emitters 262R, G, B, and emit red light, green light, and blue light, respectively. In the present embodiment, the light emitters 262R, G, B includes light emitting diodes, but may instead employ semiconductor lasers or other solid state light sources.

As in the first embodiment, the analog image data supply circuit 120B has the function of supplying analog image data FD to the liquid crystal light valves 220R, G, B. In the present embodiment, the analog image data supply circuit 120B also has the function of deciding whether an image for display is a still picture or a moving picture. This decision involves executing pattern matching using continuous two image data, for example. If the two image data match, the image for display is decided to be a still picture, and if the two image data do not match, the image for display is decided to be a moving picture.

As in the first embodiment, the control circuit 150B has the function of controlling the light emitter drive circuit 112, the analog image data supply circuit 120B, and the three liquid crystal light valves 220R, G, B. In the present embodiment, the control circuit 150B has a first operating mode and a second operating mode. The control circuit 150B acquires from the analog image data supply circuit 120B the result of the decision regarding the image for display, and selects an operating mode according to the result of the decision. If the image for display has been decided to be a still picture, the first operating mode is selected, and if the image for display has been decided to be a moving picture, the second operating mode is selected.

The control circuit 150B has a function of supplying the light emitter drive circuit 112 with a power selection signal PS depending on the selected operating mode. Specifically, if the image for display is decided to be a still picture (i.e. if the first operating mode is selected), the control circuit 150B supplies the light emitter drive circuit 112 with a first power selection signal PSI such that light of relatively low intensity is emitted from the light emitters 262R, G, B. On the other hand, if the image for display is decided to be a moving picture (i.e. if the second operating mode is selected), the control circuit 150B supplies the light emitter drive circuit 112 with a second power selection signal PS2 such that light of relatively high intensity is emitted from the light emitters 262R, G, B.

In addition, the control circuit 150B has a function of supplying the light emitter drive circuit 112 with a control signal LS depending on the selected operating mode. Specifically, if the image for display is decided to be a still picture (i.e. if the first operating mode is selected), the control circuit 150B supplies the light emitter drive circuit 112 with a first control signal LS1 such that light is emitted continuously from the light emitters 262R, G, B. On the other hand, if the image for display is decided to be a moving picture (i.e. if the second operating mode is selected), the control circuit 150B supplies the light emitter drive circuit 112 with a second control signal LS2 such that light is emitted intermittently from the light emitters 262R, G, B.

As in the first embodiment, the light emitter drive circuit 112 supplies power to the light emitters 262R, G, B, and drives the light emitters 262R, G, B. In the present embodiment, however, the light emitter drive circuit 112 changes power supplied to the light emitters 262R, G, B depending on the power selection signals PS1, PS2 given from the control circuit 150B. Specifically, if the first power selection signal PS1 is received (i.e. if the first operating mode is selected), the light emitter drive circuit 112 supplies a first power to the light emitters 262R, G, B. On the other hand, if the second power selection signal PS2 is received (i.e. if the second operating mode is selected), the light emitter drive circuit 112 supplies a second power greater than the first power to the light emitters 262R, G, B. In the present embodiment, the light emitter drive circuit 112 further changes period for supplying power to the light emitters 262R, G, B depending on the control signals LS1, LS2 given from the control circuit 150B.

Note that, the light emitters 262R, G, B in the present embodiment correspond to a light source device in the present invention, and the control circuit 150B and light emitter drive circuit 112 correspond to a controller in the present invention.

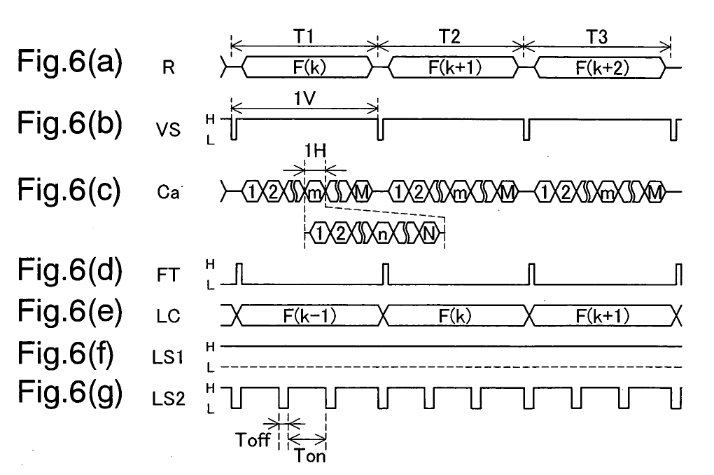

FIGS. 6(a)-6(g) are timing charts relating to operation of the liquid crystal light valve 220R in the second embodiment. FIGS. 6 (a)-6(e) are the same as FIGS. 4 (a)-4(e), and FIGS. 6 (f) and 6(g) are additional.

FIG. 6 (f) shows the first control signal LS1 supplied to the light emitter drive circuit 112 if the image for display is decided to be a still picture (i.e. if the first operating mode is selected). FIG. 6 (g) shows the second control signal LS2 supplied to the light emitter drive circuit 112 if the image for display is decided to be a moving picture (i.e. if the second operating mode is selected). During the period that the control signal LS1, LS2 is set to H level, the light emitter drive circuit 112 supplies power to the light emitters 262R, G, B, and during the period that the control signal LS1, LS2 is set to L level, the light emitter drive circuit 112 does not supply power to the light emitters 262R, G, B. That is, the H level period is a lighting period of the light emitters 262R, G, B, and the L level period is a lights-out period of the light emitters 262R, G, B.

As shown in FIG. 6(f), the first control signal LS1 is maintained at H level. Specifically, in the first mode which is selected in the case of still picture display, the light emitters 262R, G, B are maintained in the lit state. As shown in FIG. 6(g), on the other hand, the second control signal LS2 contains L level pulses occurring intermittently. That is, in the second mode which is selected in the case of moving picture display, the light emitters 262R, G, B are extinguished intermittently. In the present embodiment, the frequency of the second control signal LS2 is set to triple the frequency of the vertical synchronization signal VS.

By utilizing the second control signal LS2 shown in FIG. 6(g) in the case where a moving picture is displayed, moving picture blur can be reduced.

It is well known that images are displayed by impulse method in CRTs or plasma panels, whereas images are displayed by the hold method in liquid crystal panels. In the impulse method, a non-display period in which no image is displayed is present within one frame period (1V period), whereas in the hold method, there is no non-display period in one frame period (1V period). Thus, in the hold method, deviation can occur between an actual position of an object represented within an image, and a position of the object predicted by an observer, producing moving picture blur as a result.

In the present embodiment, however, as shown in FIG. 6 (g) three lights-out periods are provided, so three non-display periods are present within one frame period (1V period). That is, in the present embodiment, images are displayed by a “virtual” impulse method. Thus, moving picture blur can be reduced.

In the present embodiment, the frequency of the second control signal LS2 is set to triple the frequency of the vertical synchronization signal VS, but may instead be set to any multiple of 1 or greater. However, where the frequency of the second control signal LS2 is relatively low, the lights-out periods, i.e. the non-display periods, will tend to be noticeable and flicker will tend to occur. For this reason, it is preferable that the frequency of the second control signal LS2 is at least twice the frequency of the vertical synchronization signal VS. By so doing, it is possible to inhibit the occurrence of flicker due to the presence of non-display periods in images. Also, while in the present embodiment, the period during which the second control signal LS2 is set to L level is equivalent to about 20% of one cycle of the second control signal LS2, it may instead be set to a period equivalent to about 10% to about 40%.

In particular, in the present embodiment, during the period that the transfer signal FT is set to H level, the second control signal LS is set to L level and a non-display period (lights-out period) is provided between the first image (e.g. the k-th frame image) and the second image (e.g. the (k+1)-th frame image). Accordingly, as compared to the case where the above two periods do not overlap and where the second image is displayed immediately after the first image, sudden transition, noticeable to the observer, from the first image to the second image is suppressed, and moving picture blur can be reduced efficiently.

Where the power (wattage) supplied to the light emitters 262R, G, B from the light emitter drive circuit 112 is the same in both the first operating mode and the second operating mode, the total quantity of light (i.e. the cumulative quantity of light) emitted from the light emitters 262R, G, B in the second operating mode will be less than the total quantity of light output in the first operating mode. Specifically, where the lighting period is designated as Ton and the lights-out period as Toff, the total quantity of light emitted in the second operating mode will equal the total quantity of light emitted in the first operating mode multiplied by Ton/(Ton+Toff). Thus, in the second operating mode, the brightness of images perceived by the observer (cumulative luminance) will be lower. Therefore, in the present embodiment, when receiving the second power selection signal PS2 in the second operating mode, the light emitter drive circuit 112 supplies a relatively higher second power W2 to the light emitters 262R, G, B. Specifically, where the first power supplied to each light emitter 262R, G, B in the first operating mode is denoted as W1, the second power W2 is represented by the following equation.

W2=W1×(1+Toff/(Ton+Toff))

In the second operating mode, if the light emitter drive circuit 112 supplies each light emitter 262R, G, B with the second power W2, the total quantity of light in the second operating mode will be substantially equal to the total quantity of light in the first operating mode, so decline of image brightness in the second operating mode can be prevented.

Moreover, in the second operating mode, the lights-out periods are provided, and the intensity of the light emitted from each light emitter 262R, G, B during the lighting periods is higher than in the first operating mode, contrast can be improved more than in the first operating mode.

Furthermore, since lights-out periods for the light emitters 262R, G, B are provided in the second operating mode, it is possible to ameliorate decrease in lifespan of the light emitters 262R, G, B due to the light emitters 262R, G, B being driven at the higher second power W2.

The present invention is not limited to the above examples and embodiments set forth hereinabove, and can be reduced to practice in various ways without departing from the spirit thereof, such as the following variations, for example.

(1) In the preceding embodiments each cell 302 includes the buffer circuit BF, but the buffer circuit BF may be omitted. However, in this case, during transfer of pixel data, the pixel data value (voltage value) is reduced due to on-resistance of the second transistor TRb, so it is preferable to pre-establish relatively large amplitude for the analog image data FD.

(2) In the preceding embodiments each liquid crystal light valve 220R, G, B is a single device having integrally formed therein the cell array that includes the plurality of cells 302, and the drive circuitry that includes the three circuits 320, 330, 340. However, the cell array and the drive circuitry may instead be constituted as two independent devices. Alternatively, the plurality of liquid crystal elements LC and the other electrical circuitry (i.e. the electrical circuitry in the cell array and the drive circuitry) may be constituted as two independent devices.

(3) In the preceding embodiments, the present invention is applied to liquid crystal light valves 220R, G, B, but the invention may instead be applied to devices of other types. For example, the present invention may be applied to a light modulating device of micromirror type such as a DMD (Digital Micromirror Device) (trademark of TI inc.). The present invention may also be applied to devices of self emission type such as PDP (Plasma Display Panel), FED (Field Emission Display), and EL (electroluminescence) display.

In general, the display device will include a plurality of light outputting elements.

(4) In the first embodiment, the illumination optical system including the light source lamp 212 is employed, but instead of this, an illumination optical system including light emitters (i.e. solid state light sources such as LEDs) like those in the second embodiment may be employed. Also, in the second embodiment, the illumination optical system including the light emitters 262R, G, B is employed, but instead of this, an illumination optical system including a light source lamp (i.e. a mercury lamp or other discharge tube) like those in the first embodiment may be employed.

(5) In the preceding embodiments, the display system of the present invention is applied to a projector, but may instead be applied to a direct-view device.

(6) In the preceding embodiments, some of the arrangements realized through hardware may be replaced by software, and conversely some of the arrangements realized through software may be replaced by hardware.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A display device comprising:
a plurality of light outputting elements; and
a plurality of element controllers corresponding to the plurality of light outputting elements,
wherein in response to a predetermined signal provided to the plurality of element controllers at same timing, each of the plurality of element controllers supplies the light outputting element with pixel data included in image data that represents an image to be displayed by the display device, and controls an operating status of the light outputting element.

2. A display device according to claim 1, wherein each of the plurality of element controllers comprises:
a memory section that stores the pixel data; and
a supply section that supplies the pixel data stored in the memory section to the light outputting element in response to the predetermined signal.

3. A display device according to claim 2, wherein the supply section comprises:
an amplifying section that amplifies the pixel data stored in the memory section during the supply of the pixel data stored in the memory section to the light outputting element, such that a value of the pixel data stored in the memory section and a value of the pixel data received by the light outputting element are equal to one another.

4. A display device according to claim 1 further comprising:
a selector that selects the plurality of element controllers at mutually different timing,
wherein each of the plurality of element controllers further comprises:
an acquiring section that, when selected by the selector, acquires the pixel data externally provided and supplies the acquired pixel data to the memory section.

5. A display system comprising:
the display device according to claim 1;
a light source device that emits light towards the plurality of light outputting elements; and
a controller that controls the light source device such that light intermittently enters the plurality of light outputting elements.

6. A display system according to claim 5, wherein the controller controls the light source device such that light does not enter the plurality of light outputting elements during a time that the plurality of pixel data is supplied to the plurality of light outputting elements in response to the predetermined signal.

7. A display system according to claim 5, wherein the controller has:
a first operating mode for causing the light source device to continuously emit light towards the plurality of light outputting elements; and
a second operating mode for causing the light source device to intermittently emit light towards the plurality of light outputting elements,
and wherein the controller supplies the light source device with a first power during the first operating mode, and supplies the light source device with a second power greater than the first power during the second operating mode.

8. A display device comprising:
a plurality of light outputting elements; and
an operating status controller that simultaneously controls operating status of the plurality of light outputting elements at predetermined timing, such that an image displayed by the display device is changed all at one time from a first image to a second image different from the first image.
